(19) United States
(12) Patent Application Publication
(10) Pub. No.: US 2019/0122499 A1
(43) Pub. Date: Apr. 25, 2019

(54) ENTERTAINMENT SYSTEM FOR CASINO WAGERING

(71) Applicant: Chi Fat Au-Yeung, Birmingham (GB)

(72) Inventor: Chi Fat Au-Yeung, Birmingham (GB)

(21) Appl. No.: 16/108,349

(22) Filed: Aug. 22, 2018

(30) Foreign Application Priority Data
Oct. 22, 2017 (GB) 1717335.2

(51) Int. Cl. G07F 17/32; A63F 1/06; A63F 1/02

(52) U.S. Cl. CPC G07F 17/3288; G07F 17/3293; A63F 2003/00164; A63F 1/02; A63F 1/067

(57) ABSTRACT

A method, system, and computer readable storage to implement an entertainment system which can be used for wagering. A side wager can be based on a point total of two initial cards dealt. If the point total occurs, then the side wager would win and if the point total does not occur then the side wager would lose.

### CROSS REFERENCE TO RELATED APPLICATIONS

This application claims benefit to UK application number 1717335.2 filed in the United Kingdom Intellectual Property Office on Oct. 22, 2017, which is incorporated by reference herein in its entirety.

### BACKGROUND OF THE INVENTION

### Field of the Invention

The present general inventive concept is directed to a method, apparatus, and computer readable storage medium directed to a wagering game. The wagering game can be played physically in a physical casino or electronically.

### Description of the Related Art

Casino table games using cards (both played in live format and electronic format) are a billion dollar industry. The industry is also striving to produce new and exciting wagering methods which players may find fresh and exciting and the house (casino) finds profitable.

FIG. 1 is a flowchart illustrating a method of implementing the known game of blackjack.

Points totals are computed by adding the standard rank value of each card, with face valued cards (tens, jacks, queens, kings) being given a value of 10, and aces being given a value of 1 or 11, whichever results in a better hand. A soft point total is where at least one ace is given the value of 11. A hard point total is a hand with all aces counting as 1.

In operation 100, the player makes a main wager by placing chips on a table. Then, in operation 102, the dealer deals two initial cards (or “initial two cards”) to each player (either face up or face down although the player would always have the opportunity to view his/her own face down initial two cards) and two initial cards to the dealer, typically one face down (“hole-card”), and one face up (the “up-card”). Then the player can decide whether to hit, stand, double, or split. If the player decides to hit, then the method proceeds to operation 106, which deals an additional card to a player. If a determination 108 determines that the player has busted (the player's hard point total is over 21), then the player loses the game and thus loses the main wager in operation 110, which ends the game. If the determination 108 determines that the player has not busted, then the method returns to operation 104, where the player can make another decision whether to hit or stand. In operation 104, the player can also double (not pictured) by place an additional wager of up to the main wager, but the player is limited to drawing only one additional card before the player must stand.

If the player stands and has not busted out (either stands on his or her initial two cards or draws cards but has a point total under 22 and then stands), then the method proceeds to operation 112, which reveals all dealer's cards (e.g., turns the hole-card face up) and which then plays out the dealer's hand according to predetermined rules. In operation 114, if the dealer's total is greater than a predetermined amount (typically 17), then the dealer stands (proceeds to operation 122). If the dealer's total is not greater than the predetermined amount, the method proceeds to operation 116 which deals an additional card to the dealer. If it is then determined 118 that the dealer has not busted (has a point total over 21), the method returns to operation 114. If the dealer has busted, then the player wins the game and the main wager in operation 120 (this assumes the player has not also busted; if the player has already busted then the player would have lost in operation 110).

In operation 122, both the player and the dealer have played out their hand and neither have busted. Thus, their respective point totals (adding the numerical values of each card in the hand) are compared. If the dealer's point total is determined in operation 124 to be lower than the player's point total, then the player wins the game and the main wager in operation 120. Otherwise, if the dealer's point total is determined 128 to be greater than the player's point total, then the player loses the game and the main wager in operation 130. If the player's point total ties the dealer's point total, then that results in a “push” in operation 126 in which the player doesn't win or lose the main wager (the main wager is a wash).

If a player is initially dealt two identically ranked cards in operation 102 (e.g., two 2's, two 10-valued cards, etc.), players can also split in operation 104 by placing an additional split wager equal in value to the main wager, and the player's two initial cards are separated and the dealer deals an additional card on each. The player then plays out each of the two separate hands, each from operation 104 as separate hands. Depending on house rules, players may or may not be allowed to resplit cards.

### SUMMARY OF THE INVENTION

It is an aspect of the present invention to provide an exciting casino system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating a method of implementing a prior art blackjack game, according to an embodiment;

FIG. 2 is a further flowchart illustrating the exemplary method of implementing a blackjack variation, according to an embodiment;

FIG. 3A is a drawing illustrating a table layout for blackjack, according to an embodiment;

FIG. 3B is a drawing illustrating a table layout for baccarat, according to an embodiment;

FIG. 3C is a drawing illustrating an enlarged betting area for a single player of the baccarat table layout, according to an embodiment;

FIG. 4A is a block diagram illustrating exemplary hardware that can be used to implement an electronic version of the methods described herein; and

FIG. 4B is a block diagram illustrating an exemplary network configuration to implement a player playing an online version of the methods described herein.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The game of blackjack is described in U.S. patent publication 2003/0155715 which is incorporated by reference herein in their entireties. The game can be played with any number (e.g., 1-8) of standard 52 card decks.

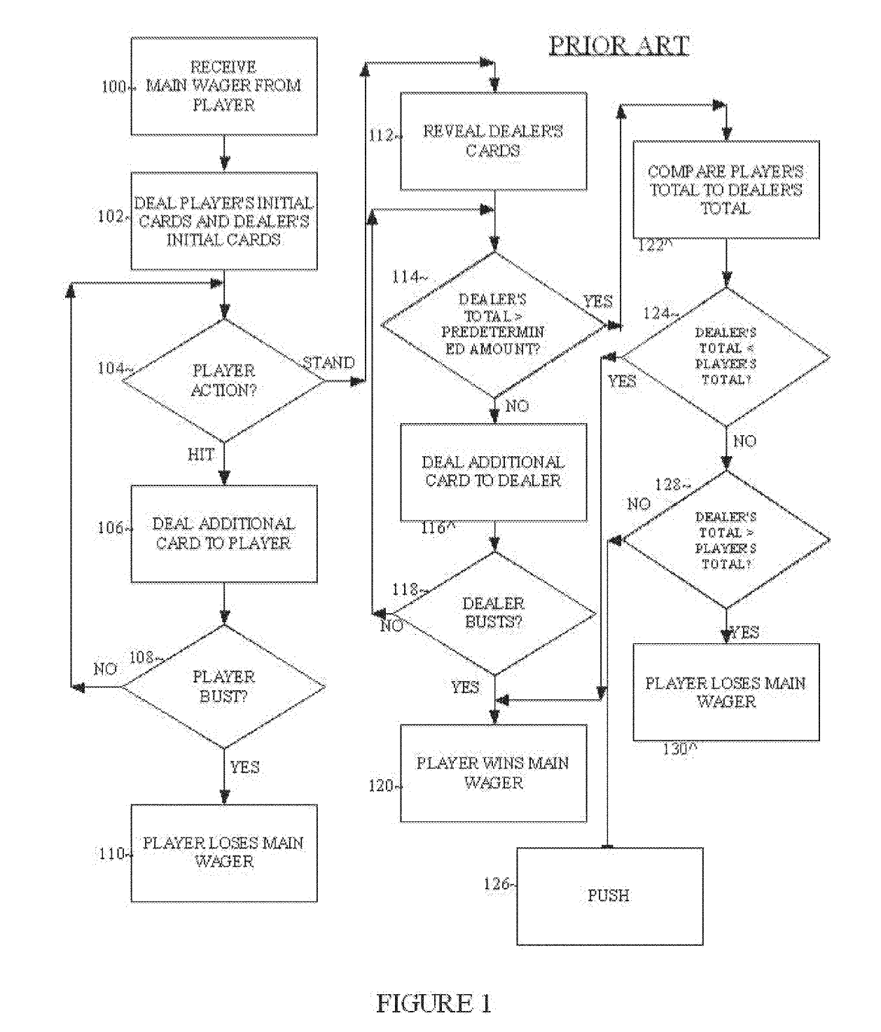

FIG. 1 is a flowchart illustrating a method of implementing the known game of blackjack.

In general, casino blackjack is played by one or more players at a gaming table against a dealer using one or more decks of cards (each deck can be a standard 52 card deck). The idea is for the player to make a point total closest to 21 without going over 21 (busting). Each player (after making a main wager) is dealt two initial cards (typically face up) and the dealer is also dealt two cards (one face up—the upcard, and one face down—the hole card). The player can stand on his or her initial two cards, or continuously hit (take another card) until the player stands or the player's point total is over 21 (upon which the player automatically loses). If the player has not busted, then after the player stands the dealer will play out the dealer's hand according to predetermined rules. One set of dealer predetermined rules is as follows: the dealer will continuously hit until the dealer's point total is greater than 16. Once the dealer has resolved the dealer's hand, the wager is resolved. If the player has busted then the player loses (the main wager). If the player has not busted but the dealer has busted (the dealer's point total is over 21) then the player wins (wins even money on the main wager). If both the player and the dealer have not busted, then if the player's point total is higher than the dealer's point total then the player wins (wins even money on the main wager). If both the player and the dealer have no busted, then if the dealer's point total is higher than the player's point total then the dealer wins (the player loses the main wager). If the player's point total equals the dealer's point total, then the main wager pushes (neither wins nor loses). Other options the player may have at his or her disposal is to double down or split. Cards are given their standard numerical value (i.e., aces count as 1 or 11 (whichever makes the best hand), 2's-10's count as their respective face value, jacks, queens, and kings all count as 10).

The present inventive concept relates to a method, apparatus, and computer readable storage medium to implement a blackjack game which provides the player an opportunity to place a side wager (“side wager” is synonymous with “side bet”). The side wager would pay when the player's point total of the player's initial two cards are in a predetermined set of point totals. If the player's point total of the player's initial two cards are not in the predetermined set of point total, then the side wager loses. Note that the side wager is different from the main wager, and it is possible for the player to win the main wager and lose the side wager and vice-versa.

TABLE I

| Point total of initial | | |
|---|---|---|
| two cards | Hand Composition | Payout |
| 20 | any two face cards | 2:1 |
| 10 | Any of 9-1, 8-2, 7-3, or 6-4 | 10:1 |
| 10 | 5-5 | 23:1 |
| All other totals | doesn't matter | −1 (loses) |

As known in the art, face cards consist of all tens (10), jacks, queens, and kings, but no other ranks qualify as face cards. The suit does not matter. Thus, there are 16 face cards in a standard 52 card deck (four 10's, 4 jacks, 4 queens and 4 kings). In a shoe of six decks there would be 6*16=96 face cards. This in Table 1, if the initial two cards have a point total of 10 or 20 the side wager would win, otherwise it would lose. The point total is determined by adding the value of each card together. Aces have a value of 1 (although in other embodiments, aces can have a value of 11, or either 1 or 11 depending on which is better for the player). 2's have a value of 2; 3's have a value of 3; 4's have a value of 4; 5's have a value of 5; 6's have a value of 6; 7's have a value of 7; 8's have a value of 8; 9's have a value of 9; 10's have a value of 10; jacks have a value of 10; queens have a value of 10; and kings have a value of 10.

Table II below is another example paytable. Table II is similar to Table I but aces now count as 11.

| Point total of initial | | |
|---|---|---|
| two cards | Hand Composition | Payout |
| 20 | ace-9 or any two face cards | 3:1 |
| 10 | any of 8-2, 7-3, or 6-4 | 10:1 |
| 10 | 5-5 | 22:1 |
| All other totals | doesn't matter | −1 (loss) |

Table III below is another example paytable, this paytable can be considered a “11 or 21” paytable since the winning point totals are 11 and 21.

TABLE III

| Point total of initial | | |
|---|---|---|
| two cards | Hand Composition | Payout |
| 21 | any two cards from King, | 5:1 |
| | Queen, Jack, 10 plus Ace | |
| 11 | any of 9-2, 8-3, 7-4, or 6-5 | 10:1 |
| 11 point suited | any of 9-2, 8-3, 7-4, or 6-5 suited | 21:1 |
| All other totals | doesn't matter | −1 (loss) |

In the example illustrated in Table III, the winning point totals are 11 and 21. Note that “suited” means both cards in the initial hand are the same suit. Thus “11 point suited” means that both cards (one of 9-2, 8-3, 7-4, 6-5) are the same suit.

Table IV below is another embodiment in which the winning point totals are 9 and 19. Suite means both card in the initial hand are the same suit.

TABLE IV

| Point total of initial | | |
|---|---|---|
| two cards | Hand Composition | Payout |
| 19 point | any two cards out of King, Queen, | 5:1 |
| | Jack, 10 and a 9 | |
| 9 point | any of 9-1, 7-2, 6-3, 5-4 | 10:1 |
| 9 point suited | any of 8-1, 7-2, 6-3, 5-4 | 21:1 |
| All other totals | doesn't matter | −1 (loss) |

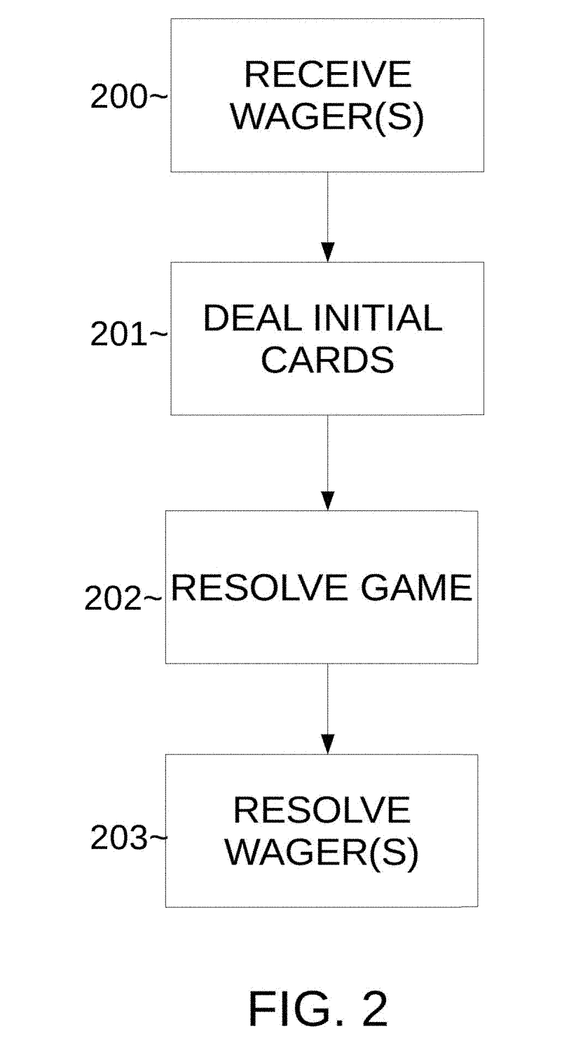

FIG. 2 is a further flowchart illustrating the exemplary method of implementing a blackjack variation, according to an embodiment.

In operation 200, all players' wager(s) are received. In blackjack, the main wager is typically mandatory and any side wager(s) can be optional on the part of the player. In baccarat, the main wager can be placed on the player or banker, and any side wager(s) can also be optional. In the physical embodiment, wagers (bets) are made by placing chips (which are directly redeemable for cash) on a physical table. In the electronic version, the player would view a graphical user interface (GUI) displayed on an electronic output/display unit and indicate his/her decisions using an input device (e.g., a touch-screen) such as how much to bet.

From operation 200, the method proceeds to operation 201, wherein the initial cards are dealt. This can be done as known in the art. In the physical version, physical cards are used/dealt (typically shuffled periodically) from one or more physical decks. In the electronic version, a virtual deck(s) is maintained and random cards are dealt (displayed) to the player(s). In blackjack, the initial cards would include the initial two cards dealt to each player which the side wager payout is based upon. In baccarat, the initial cards would include the initial two player cards (which are used to determine the payout of the side wager) dealt in the center of the table.

From operation 201, the method proceeds to operation 202, which completes the game. This is done according to the predetermined rules for each game (e.g., blackjack, baccarat, etc.)

From operation 203, the method proceeds to operation 204, which resolves all wagers that were placed. This includes any and all side wagers (side bets) that were placed. The side wager(s) are resolved by comparing the respective initial two cards to a paytable being used for the side wager and determine whether the player wins, and if so, how much. If the initial two cards match a winning combination on the paytable then the player wins a payout for that combination, otherwise the player loses. Losing side wagers get no payout and are collected (kept) by the house/casino. Winning side wagers are paid their respective amount based on the payout (the payout in the paytable multiplied by the amount of the side wager). In the physical game payouts are made in physical chips, and in the electronic (virtual) version payouts are made in credits which are displayed on the electronic output device.

All other wagers (e.g., main wagers, etc.) are resolved according to the game's rules. In blackjack a player typically makes a main wager on the outcome of the game. In baccarat, the main wager is considered whichever bet (banker or player) that the player chose to make on that hand.

Note that the embodiments described herein can also be applied to baccarat.

The present inventive concept relates to a method, apparatus, and computer readable storage medium to implement a baccarat game. Baccarat is well known in the art, for example see U.S. Pat. No. 6,299,171 and U.S. pre-grant publication 2008/0032760, both documents of which are incorporated by reference herein in their entireties.

The rules of standard Baccarat are summarized in Table V below.

TABLE V
1) Usually eight decks of cards are used.
2) Cards are given point values as follows: ace = 1, 2-9 = pip
value, 10 and face cards = 0.
3) At the start of a new shoe, the dealer will turn over one card.
This will determine how many cards the dealer will burn, according
to the baccarat value, except a 10 or face card will result in 10
cards burned.
4) The cut card will be placed 16 cards from the bottom of the shoe.
When the cut card appears, the dealer will finish that hand, play one
more hand, and then start a new shoe. If the cut card comes out instead
of the first card, the dealer will finish that hand, and then start a new shoe.
5) Play begins by all players betting either on the “player”, “banker”,
or a tie. At some tables you may also bet on a player pair and banker pair.
6) After all bets are down, the dealer gives two cards each to the player
and the banker. The score of the hand is the right digit of the total of
the cards. For example, if the two cards were an 8 and 7, then the total
would be 15 and the score would be a 5. The scores will always range
from 0 to 9 and it is impossible to bust.
7) A third card may or may not be dealt to either the player or the dealer
depending on the following rules. A) If either the player or the banker has
a total of an 8 or a 9 they both stand. This rule overrides all other rules.
B) If the player's total is 5 or less, then the player hits, otherwise
the player stands. C) If the player stands, then the banker hits on a total
of 5 or less. If the player does hit then use Table II below to determine if
the banker hits (H) or stands (S).
8) The score of the player and dealer are compared; the winner is the one
that is greater. Winning bets on the banker pay 19 to 20 (or even money
less a 5% commission), winning bets on the player pay 1 to 1, winning
bets on a tie usually pay 8 to 1. In the event of a tie, banker and player
bets will push.
9) On winning banker bets, the player will be paid even money.
Meanwhile, the dealer will keep track of the 5% commission owed with
small laminated markers. At the end of each shoe, or when a player
wants to leave, the dealer will collect all commissions owed.

Table VI below shows the Baccarat drawing rules for the player's third card

TABLE VI

| Banker's Score | player's third card 0123456789 |
|---|---|
| 7 | SSSSSSSSSS |
| 6 | SSSSSSHHSS |
| 5 | SSSSHHHHSS |
| 4 | SSHHHHHHSS |
| 3 | HHHHHHHHSH |
| 2 | HHHHHHHHHH |
| 1 | HHHHHHHHHH |
| 0 | HHHHHHHHHH |

The rules of standard baccarat are also rephrased here. The player chooses a bet to place (player, banker, or tie). This player bet is also referred to as the standard player bet/wager and this banker bet is also referred to as the standard banker bet/wager. Because these bets are unchanged from the standard game of Baccarat. The cards are dealt face down, two cards to the player and two cards to the banker, all face up. Depending on the two initial hands, both the player and the banker may draw a third card or stand. The hand with the higher total wins.

If the player or the banker (or both) achieve a total of 8 or 9 on the initial deal (known as a ‘natural’), no further cards are drawn and the game is evaluated based on both initial two card hands. If neither player has a natural, then the play proceeds as follows. If the player has an initial total of 0-5, the player draws a third card. If the player then has an initial total of 6 or 7, the player stands.

If the player stands, the banker uses only the banker's own hand and acts according to the same rule as the player (the banker draws a third card if the banker has 0-5 and stands if the banker has 6 or 7).

If the player drew a third card, then the banker acts according to Table VII.

TABLE VII

| Player Draw Card | Banker Action |
|---|---|
| 2-3 | banker draws if banker has 0-4, stands if banker |
| | has 5-7 |
| 4-5 | banker draws if banker has 0-5, stands if banker |
| | has 6-7 |
| 6-7 | banker draws if banker has 0-6, stands if banker |
| | has 3-7 |
| 8 | banker draws if banker has 0-2 and stands if banker |
| | has 3-7 |
| A, 9, 10 or face card | banker draws if banker has 0-3 and stands if banker |
| | has 4-7 |

The player (player or banker) with the highest hand wins. The score of each hand is computed by taking the physical point total of each hand modulo 10, which means that after adding the value of the cards the tens digit is ignored. For example, a hand of 3 and 4 is 7. A hand of 8 and 6 is scored as 4 (14 modulo 10). The first digit is dropped because the total is higher than 9. A hand consisting of 4 and 6 is worth zero. The highest (best) score that can be achieved is 9 (formed using 4/5; face card/9; A/8, 7/2, etc.)

The side wagers described herein can be applied to baccarat, utilizing the player's initial two cards in order to determine whether the side wager wins (and if so what the payout is) in the same manner as blackjack. In addition, the side wagers described herein can also be applied to baccarat utilizing the dealer's initial two cards as well.

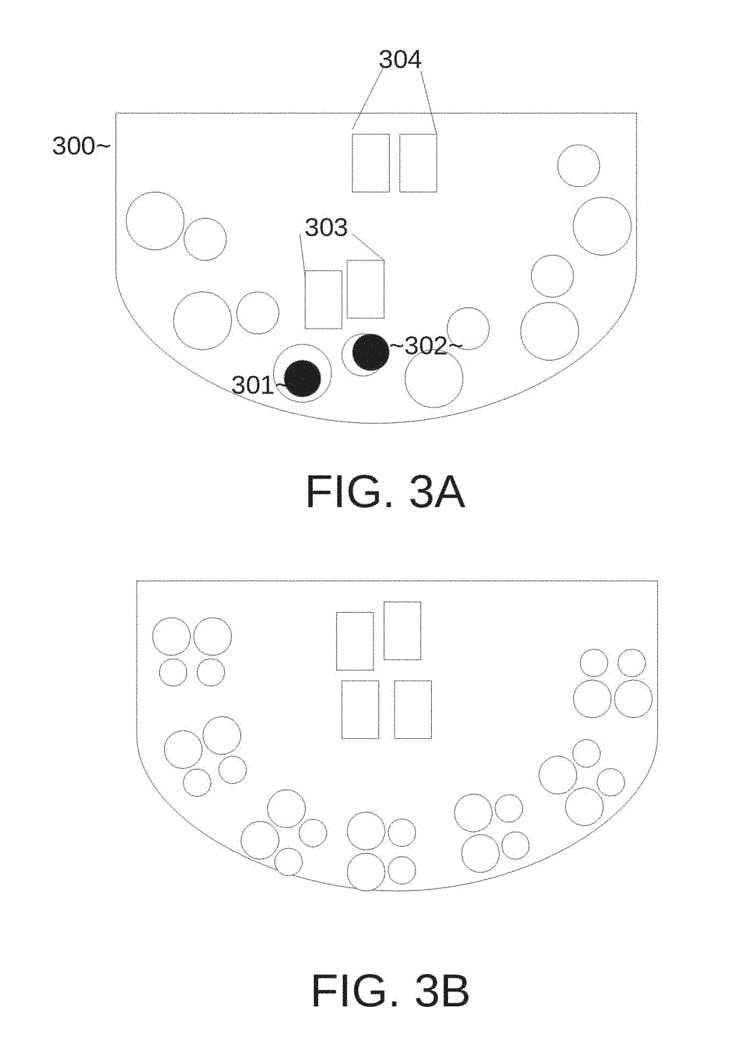

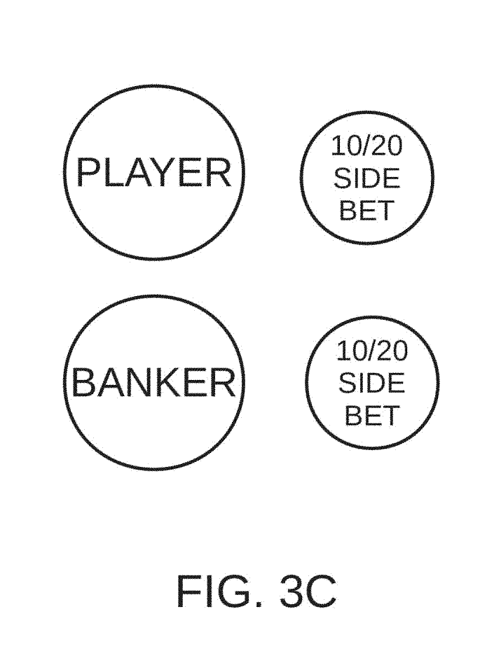

FIG. 3A is a drawing illustrating a table layout for blackjack, according to an embodiment.

A physical blackjack table 300 has a betting layout imprinted on its top felt layer. This table can accommodate six simultaneous players, although tables can accommodate any other number of players as well. A dealer's hand 304 and a player's hand 303 are dealt. The player's hand 303 is dealt face up and this the initial two cards that is used to resolve the side wager. In this particular example, only one player is playing who has placed a main wager 301 in chips and a side wager 302 in chips.

FIG. 3B is a drawing illustrating a table layout for baccarat, according to an embodiment.

A physical baccarat table is shown which has its betting layout imprinted on the felt. This table can accommodate seven simultaneous players, although tables can accommodate any other numbers of players of well. Each betting area (of seven) has a betting circle for the player bet and a betting circle for the banker bet. Each betting area also has a betting circle for a side bet which is based on the player's initial two cards, and a betting area for a side bet which is based on the dealer's initial cards. Players can optionally bet on none, one, or both of these side bets at the same time. Typically, the player would not want to bet on the player and banker at the same time.

FIG. 3C is a drawing illustrating an enlarged betting area for a single player of the baccarat table layout, according to an embodiment.

The player can bet on any combination four possible betting circles, although the player would be foolish to bet on both the player bet and banker bet simultaneously. The top “10/20 side bet” betting circle is the side bet which is based upon the player's initial two cards, and the bottom “10/20 side bet” betting circle is the side bet which is based upon the dealer's (banker's) initial two cards. The player may wish to bet on both side bets as they are independent of each other (one can in while they other loses, both can lose, and both can win).

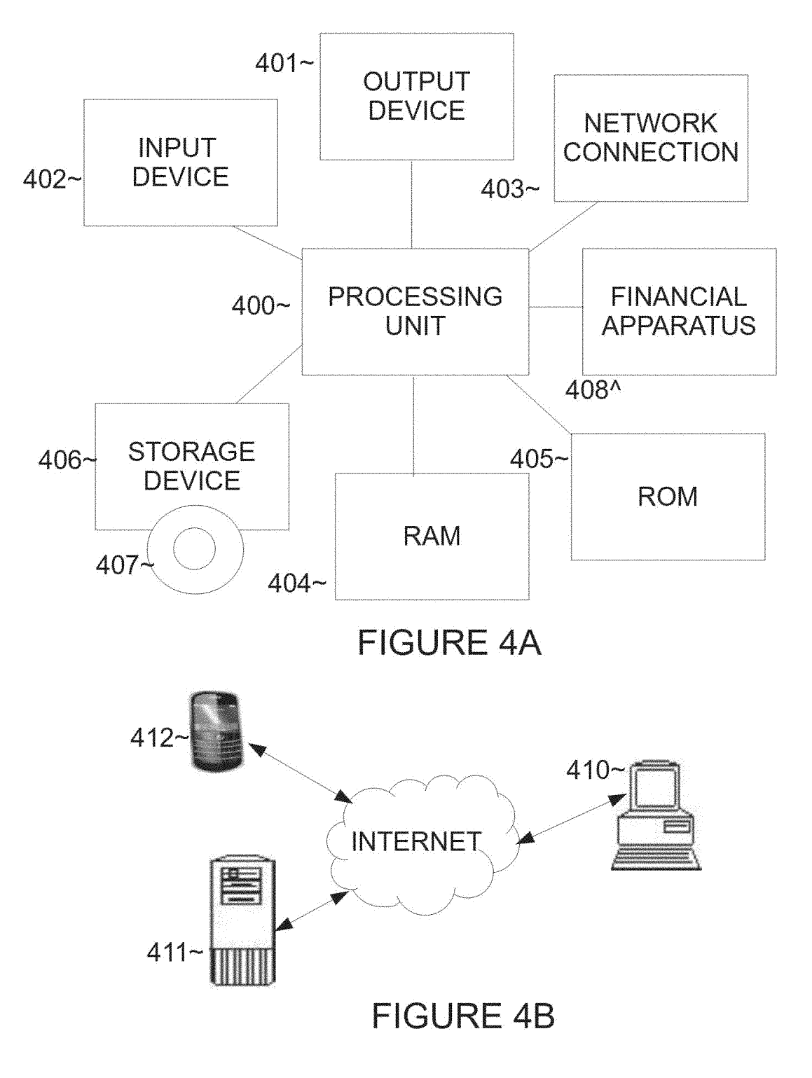

FIG. 4A is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The hardware can also be any computing device, such as a cellular phone, tablet, etc., and the methods described herein can be installed as software (e.g., an app) on the device. The hardware can also be any other type of device, working individually or in conjunction with other devices. The hardware can also be a digital table, of the kind described in U.S. Pat. No. 7,758,411 which is incorporated by reference herein in its entirety.

A processing unit 400 (such as a microprocessor and any associated components) is connected to an output device 401 (such as an LCD monitor, touch screen, CRT, etc.) which is used to display to the player any aspect of the method (including dealt cards, bets made, etc.), and an input device 402 (e.g., buttons, a touch screen, a keyboard, mouse, etc.) which can be used to input from the player any decision made by the player (such as how much to bet, player strategy decisions, etc.) All methods described herein can be performed by the processing unit 400 by loading and executing respective instructions. The processing unit 400 can also be connected to a network connection 403, which can connect the electronic gaming device to a computer communications network such as the Internet, a LAN, WAN, etc. The processing unit 400 is also connected to a RAM 404 and a ROM 405. The processing unit 400 is also connected to a storage device 406 which can be a DVD-drive, CD-ROM, flash memory, etc. Multiple such processing units can also work in collaboration with each other (in a same or different physical location). A non-transitory computer readable storage medium 407 can store a program which can control the electronic device to perform any of the methods described herein and can be read by the storage device 406. The processing unit 400 can also be connected to a financial apparatus 408 which can receive cash and convert the received cash into playable credits for use by the player when playing the electronic device. When the player decides to cash out any remaining credits, the financial apparatus 408 can issue coins or a cashless ticket (voucher) for the remaining credits which is redeemable by the player.

While one processing unit is shown, it can be appreciated that one or more such processor can work together (either in a same physical location or in different locations) to combine to implement any of the methods described herein. Programs and/or data required to implement any of the methods/features described herein can all be stored on any non-transitory computer readable storage medium (volatile or non-volatile, such as CD-ROM, RAM, ROM, EPROM, microprocessor cache, etc.)

FIG. 4B is a block diagram illustrating an exemplary network configuration to implement a player playing an online version of the methods described herein. All the methods described herein can be implemented on an online casino for real money (credits which are purchased for cash and are redeemable for cash). A player uses a personal computer 410 (e.g., cell phone, tablet, PC, etc.) can connect to a server 411 (which can have the structure illustrated in FIG. 4A) using a computer communications network such as the Internet. The server 411 hosts an online casino which determines the outcomes of the game and serves the outcomes to the computer 410 so the computer 410 displays the outcomes to the player. Other users can also play at the online casino hosted by the server 411 simultaneously, such as using a cell phone 412 with wireless internet connectivity. Any number of players (e.g., 1 to 100 or more than 100) can be connected to the internet and can play simultaneously on the sever 411 even though these players are all located in different physical locations. The general structure of online casinos is well known in the art.

It is noted that the methods described herein can be played with any number of standard decks of 52 cards (e.g., 1 deck to 10 decks). A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real life image of that card.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation. All features in all documents incorporated by reference herein can be combined with any feature(s) described herein, and also with all other features in all other documents incorporated by reference, without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for implementing a wagering game, the method comprising:
providing a physical blackjack table and at least one physical deck of cards;
receiving a side wager from a player;
dealing two initial cards;
dealing additional cards and resolving the game according to predetermined rules;
providing side wager resolution rules comprising a) when a point total of both of the two initial cards is in a set of winning point totals consisting only of (X, Y) then the side wager wins, b) when the point total is not in the set of winning point totals then the side wager loses;
resolving the side wager according to the side wager resolution rules.

2. The method as recited in claim 1, wherein the side wager resolution rules further comprise X=20 and Y=10.

3. The method as recited in claim 2, wherein the side wager resolution rules further comprise that a payout for 10 is higher than a payout for 20.

4. The method as recited in claim 1, wherein the side wager resolution rules further comprise that X=21 and Y=11.

5. The method as recited in claim 4, wherein the side wager resolution rules further comprise that a payout for 11 is higher than a payout for 21.

6. The method as recited in claim 5, wherein the side wager resolution rules further comprise that if both of the two initial cards are suited and the point total is 11 then the payout for 11 is higher than if both of the two initial cards are not suited.

7. The method as recited in claim 1, wherein the side wager resolution rules further comprise that X=19 and Y=9.

8. The method as recited in claim 7, wherein the side wager resolution rules further comprise that a payout for 9 is higher than a payout for 19.

9. The method as recited in claim 1, wherein the game is blackjack.

10. The method as recited in claim 1, wherein the game is baccarat.

11. An apparatus for implementing a wagering game, the apparatus comprising:
an electronic input device, an electronic output device, and an electronic processing unit;
the electronic processing unit configured to read and execute computer readable instructions from an electronic storage, the computer readable instructions programmed to cause the electronic processing unit to perform:
receive a side wager from a player;
deal two initial cards;
deal additional cards and resolving the game according to predetermined rules;
provide side wager resolution rules comprising a) when a point total of both of the two initial cards is in a set of winning point totals consisting only of (X, Y) then the side wager wins, b) when the point total is not in the set of winning point totals then the side wager loses;
resolve the side wager according to the side wager resolution rules.

12. The apparatus as recited in claim 11, wherein the computer readable instructions are further programmed such that the side wager resolution rules further comprise X=20 and Y=10.

13. The apparatus as recited in claim 12, wherein the computer readable instructions are further programmed such that the side wager resolution rules further comprise that a payout for 10 is higher than a payout for 20.

14. The apparatus as recited in claim 11, wherein the computer readable instructions are further programmed such that the side wager resolution rules further comprise that X=21 and Y=11.

15. The apparatus as recited in claim 14, wherein the computer readable instructions are further programmed such that the side wager resolution rules further comprise that a payout for 11 is higher than a payout for 21.

16. The apparatus as recited in claim 15, wherein the computer readable instructions are further programmed such that the side wager resolution rules further comprise that if both of the two initial cards are suited and the point total is 11 then the payout for 11 is higher than if both of the two initial cards are not suited.

17. The apparatus as recited in claim 11, wherein the computer readable instructions are further programmed such that the side wager resolution rules further comprise that X=19 and Y=9.

18. The apparatus as recited in claim 17, wherein the computer readable instructions are further programmed such that the side wager resolution rules further comprise that a payout for 9 is higher than a payout for 19.

19. The apparatus as recited in claim 17, wherein the computer readable instructions are further programmed such that the game is blackjack.

20. The apparatus as recited in claim 11, wherein the computer readable instructions are further programmed such that the game is baccarat.
